(19) United States
(12) Patent Application Publication
(10) Pub. No.: US 2010/0266812 A1
(43) Pub. Date: Oct. 21, 2010

(54) PLANAR ABRASIVE ARTICLES MADE USING TRANSFER ARTICLES AND METHOD OF MAKING THE SAME

(75) Inventor: Paul S. Lugg, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/760,854

(22) Filed: Apr. 15, 2010

Related U.S. Application Data
(60) Provisional application No. 61/170,131, filed on Apr. 17, 2009.

(51) Int. Cl. B24D 3/00; B24D 3/28; B32B 37/00; B32B 5/16

(52) U.S. Cl. 428/147; 428/143; 428/148; 428/149; 51/297

(57) ABSTRACT

A transfer article useful for making an abrasive article is provided. The transfer article has a first liner having opposing first and second surfaces, the first surface having a release value of less than about 700 gram per inch per ASTM D3330/D3330M-04; and a powder comprising abrasive particles disposed on the first surface of the first liner. The transfer article can further include a second liner having opposing first and second surfaces. In one embodiment the powder is sandwiched between the first surfaces of the first and second liners. Methods of making a fixed abrasive article using the transfer article are also described.

### CROSS REFERENCE TO RELATED APPLICATION

This application claims the benefit of U.S. Provisional Patent Application No. 61/170,131, filed Apr. 17, 2009, the disclosure of which is incorporated by reference herein in its entirety.

### BACKGROUND

There are numerous ways to apply abrasive particles to a substrate. For example, U.S. Pat. No. 2,332,505 (Crompton) discloses a method of making an abrasive disk having a layer of diamond abrasives on one or both sides of the disk using a system having a hydraulic press. The method recites a first step of molding under light pressure a disk from metal powders. Thereafter, diamond abrasive grains were sprinkled onto one side of the disk. An electromagnetic force of about 10,000 volts was applied to the system such that the diamond grains acquire an electric charge thereby orienting their longest dimension. U.S. Pat. No. 5,368,618 (Masmar et al.) discloses a method of making a coated abrasive article where the presence of multiple layers of abrasive grains is minimized. One method involves the steps of providing a backing, applying a make coat precursor to the backing, partially curing the make coat precursor, applying, preferably by projecting, a plurality of abrasive grains into the partially cured make coat precursor, and completely curing the partially cured make coat precursor. In one variation, a size coat precursor is applied over the abrasive grains and cured make coat and the size coat is completely cured. In another variation, the size coat precursor is applied over the abrasive grains and the partially cured make coat precursor, and the make coat precursor and size coat precursor are completely cured.

U.S. Pat. No. 5,620,775 (LaPerre) discloses a transfer article that can be used to make a bead coated article that may have retroreflective images and non-retroreflective images. The transfer article includes (a) a transfer carrier having a support layer and a thermoplastic glass bead release layer bonded to the support layer; (b) a layer of a mixture of transparent glass beads and irregularly shaped glass particles partially embedded in the thermoplastic release layer; and (c) a layer of a first adhesive formed on the surfaces of the glass beads and the irregularly shaped glass particles not embedded in the thermoplastic release layer. A method of making a transfer article is also disclosed. The transfer coating method uses a transfer carrier, which in its simplest form, includes a support layer and a thermoplastic release layer bonded thereto. The thermoplastic release layer of the transfer carrier temporarily partially embeds a layer of glass beads.

### SUMMARY

While the prior art discussed above provide various ways for making an abrasive article or transfer articles, there remains a desire to provide a cost-effective avenue in making a transfer articles that can be used to make abrasive article.

The present disclosure provides a streamlined and economically efficient solution for making a fixed abrasive article or a non-fixed abrasive article using transfer articles. As used herein, the term “fixed abrasive article” generally refers to a condition where the abrasive particles are fixed in a cured, first binder (sometimes referred to those skilled in the as a “make coat”) and optionally a cured second binder (sometimes referred to those skilled in the art as a “size coat”). The term “cured” encompasses partially cure or fully cured condition of the first and or second binder. The term “partially cured” means a condition of the resinous binder in which the resin has begun to polymerize and has experienced an increase in molecular weight, but in which the resin continues to be at least partially soluble in an appropriate solvent. The term “fully cured” means a condition of the resinous binder in which the resin is polymerized and is in a solid state and in which the resin is not soluble in a solvent.

In one aspect, the present disclosure relates to a transfer article useful for making an abrasive article. The transfer article comprises (a) a first liner having opposing first and second surfaces, the first surface having a release value of less than about 700 gram per inch per ASTM D3330/D3330M-04 and (b) a powder comprising abrasive particles disposed on the first surface of the first liner.

In another aspect, the present disclosure relates to a transfer article comprising a first liner having opposing first and second surfaces, the first surface having a release coating selected from the group consisting of a fluorine containing material, a silicon containing material, a fluoropolymer, a silicone polymer or a poly (meth)acrylate ester derived from a monomer comprising an alkyl (meth)acrylate having an alkyl group having 12 to 30 carbon atoms. The term (meth)acrylate includes acrylate and methacrylate.

In yet another aspect, the present invention relates to the method of making a fixed abrasive article comprising the steps of (a) providing a rigid substrate having opposing first and second surfaces; (b) coating a first binder on the first surface of the rigid substrate; (c) providing a transfer article comprising (i) a first liner having opposing first and second surfaces, the first surface having a release value of less than about 700 gram per inch per ASTM D3330/D3330M-04; and (ii) a powder comprising abrasive particles disposed on the first surface of the first liner, (d) disposing the first liner on the first binder coated to the first surface of the rigid substrate such that the abrasive particles contact the first binder; (e) removing the first liner from the rigid substrate; and (f) curing the first binder thereby securing the abrasive particles to the rigid substrate.

In yet another aspect, the present invention relates to the method of making a fixed abrasive article comprising the steps of (a) providing a rigid substrate having opposing first and second surfaces; (b) coating a first binder on the first surface of the rigid substrate; (c) providing a transfer article comprising (i) a first liner having opposing first and second surfaces, the first surface having a release coating selected from the group consisting of a fluorine containing material, a silicon containing material, a fluoropolymer, a silicone polymer or a poly (meth)acrylate ester derived from a monomer comprising an alkyl (meth)acrylate having an alkyl group having 12 to 30 carbon atoms; and (ii) a powder comprising abrasive particles disposed on the first surface of the first liner; (d) disposing the first liner on the first binder coated to the first surface of the rigid substrate such that the abrasive particles contact the first binder; (e) removing the first liner from the rigid substrate; and (f) curing the first binder thereby securing the abrasive particles to the rigid substrate.

In particular, the inventor of the present disclosure recognized and took advantage of the electrostatic force that is present in a release liner, whether such liner is based on paper, polymeric film including non-woven films or fabric, to temporarily bond the abrasive particles to the liner. The electrostatic attraction between the transfer liner and the abrasive particles, however, is not so strong that the particles will not release from the liner. Unlike the prior art, the present disclosure does not use an external source of energy to impart an electric charge to the abrasive particles. Furthermore, the abrasive particles of the present disclosure are not embedded in the release liner but instead cling to the release coating side of the release liner.

In one application, the abrasive articles disclosed herein, particularly the fixed abrasive article, can be used to polish or finish an article (sometimes referred to in the industry as a “workpiece”). In some applications, it is very desirable for the fixed abrasive article to be substantially flat and to remain flat during polishing. If there is unevenness, asperities, or waviness in the fixed abrasive article, its use during polishing can lead to crowning or “roll off” of the work piece. Crowning is undesirable rounding of the work piece edges. One advantage of the present disclosure is that by starting with a substantially flat rigid substrate and then use of a transfer article disclosed herein provides an efficient and cost effective way to make the fixed abrasive article. Furthermore, the use of the transfer article allows for immense flexibility because the abrasive particles can be applied to a rigid substrate of varying geometry. So long as the transfer article is flexible, it can conform to the shape of the rigid substrate.

The transfer article disclosed herein is also useful for a non-fixed abrasive system. In contrast to the fixed abrasive system described above, the non-fixed abrasive system is one where the abrasive particles are disposed in a matrix that is typically not cured. The matrix holds the abrasive particles. Thus, in a non-fixed system, the abrasive particles are able to move during use, i.e., during a grinding process. An illustrative non-fixed abrasive system is optical polishing with pitch, where the pitch can be a viscous substance obtained as a residue in the distillation of organic materials, such as tars. The abrasive particles can be applied to the pitch using the transfer article disclosed herein. Publications that discuss optical polishing with pitch include the following: (i) R. Varshneya, J. E. DeGroote, L. L. Gregg, and S. D. Jacobs, “Characterizing Optical Polishing Pitch,” Optifab 2003 (SPIE, Bellingham, Wash., 2003), Vol. TD02, pp. 87-89; (ii) J. E. DeGroote, S. D. Jacobs, L. L. Gregg, A. E. Marino, J. C. Hayes, and R. Varshneya, “A Data Base for the Physical Properties of Optical Polishing Pitch,” in Optical Fabrication and Testing Digest (Optical Society of America, Washington, D.C., 2002), pp. 55-59; (iii) J. E. DeGroote, S. D. Jacobs, and J. M. Schoen, “Experiments on Magnetorheological Finishing of Optical Polymers,” in Optical Fabrication and Testing Digest (Optical Society of America, Washington, D.C., 2002), pp. 6-9; and (iv) J. E. DeGroote, S. D. Jacobs, L. L. Gregg, A. E. Marino, and J. C. Hayes, “Quantitative Characterization of Optical Polishing Pitch,” in Optical Manufacturing and Testing IV, edited by H. P. Stahl (SPIE, Bellingham, Wash., 2001), Vol. 4451, pp. 209-221.

In yet another aspect, the present disclosure relates to an abrasive modified substrate comprising a rigid substrate having a first and a second surface, a first binder on the first surface of the substrate, and a layer of abrasive particles disposed in the first binder, wherein the layer comprises at least two concentric regions on the first binder, each concentric region comprising abrasive particles having a feature which differs from a feature of abrasive particles of any other concentric region.

### BRIEF DESCRIPTION OF THE DRAWINGS

The invention will be further described with reference to the following drawings, wherein:

FIG. 1 is a schematic cross-sectional view of a transfer article according to another aspect of the present disclosure;

FIG. 2 is a schematic cross-sectional view of an exemplary method of making an abrasive article according to one aspect of the present disclosure;

FIG. 3 is a perspective view of a roll of transfer article according to one aspect of the present disclosure; and

FIGS. 4 and 4a are perspective views of transfer articles with concentric regions of varying abrasive particle density.

These figures are illustrative, are not drawn to scale, and are intended merely for illustrative purposes.

### DETAILED DESCRIPTION

All numbers are herein assumed to be modified by the term “about.” The recitation of numerical ranges by endpoints includes all numbers subsumed within that range (e.g., 1 to 5 includes 1, 1.5, 2, 2.75, 3, 3.80, 4, and 5). All parts recited herein, including those in the Example section below, are by weight unless otherwise indicated.

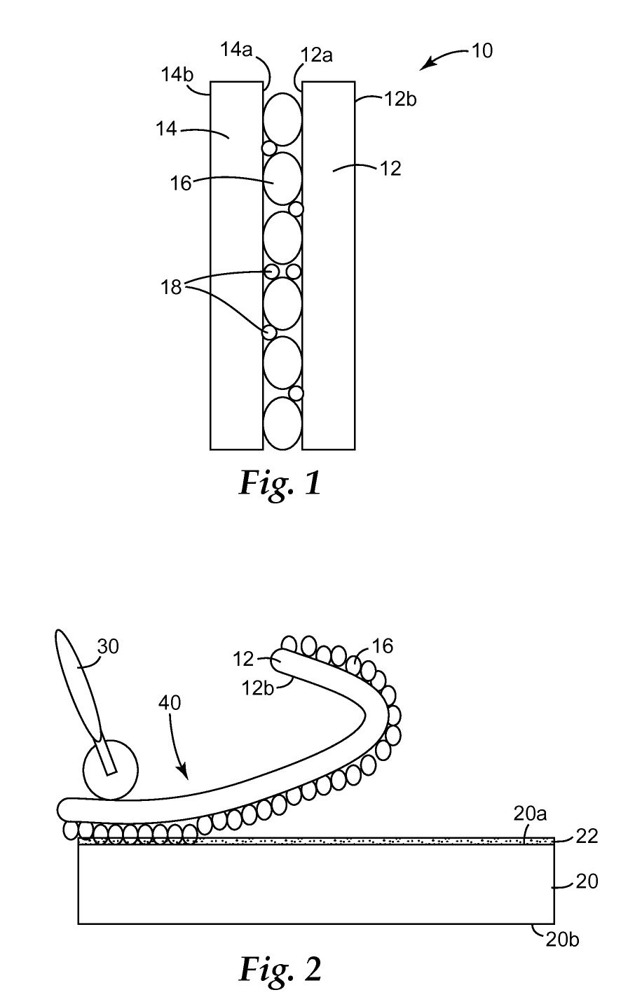

Now turning to the figures, FIG. 1 shows a schematic cross-sectional view of an exemplary dual liner transfer article 10 having a first liner 12, a second liner 14, and abrasive particles 16 disposed or sandwiched between the two liners. Each of the first and second liner has a first surface 12a and 14a respectively and an opposing second surface 12b and 14b respectively. A release coating (not shown) is disposed on the first surface 12a of the first liner and optionally on the first surface of 14a of the second liner. Optionally, a particulate vitrifiable binder 18 (sometimes referred to as a “size coat”), which can function as a second binder (as further described below), can be disposed between the first and second liners. The particulate vitrifiable binder 18 can be a thermoplastic or a thermosetting resin. While FIG. 1 shows the thermoplastic resin as smaller than the abrasive particles, the thermoplastic resin can be of the same or larger size than the abrasive particles. As used herein, a “powder” can include the abrasive particles, the particulate vitrifiable binder, and combinations thereof.

FIG. 2 shows a schematic cross-sectional view of a portion of an exemplary transfer method that can be used to make an abrasive article 40 of the present disclosure. Prior to an abrasive particle transfer step, a rigid substrate 20, having opposing first and second surfaces 20a and 20b respectively, has a first binder 22 (sometimes referred to as a “make coat”) coated on the substrate's first surface. The second liner 14 of transfer article 10 of FIG. 2 has been removed to expose the abrasive particles 16 and any particulate vitrifiable binder 18, if used, which remains on the first liner 12. The first liner is disposed on the rigid substrate such that the abrasive particles 16 are in direct contact with the first binder 22. FIG. 2 shows that pressure is manually applied, using a lamination device 30, to the second surface 12b of the first liner 12 to promote the transfer of the abrasive particles 16 and any particulate vitrifiable binder 18 from the first liner to the first binder. Other lamination techniques known to those skilled in the art can also be used. The largest abrasive particles typically penetrate the resinous binder 22 to come in direct contact with the first surface 20a of the rigid substrate. Thereafter the first liner is removed.

During the process of contacting the abrasive particles 16 and any particulate vitrifiable binder material 18, if used, to the first binder 22, the resinous binder material should be in a tacky state. That is, the first binder should have sufficient tack to enable at least 20%, more preferably at least 50% and most preferably at least 70% of the abrasive particles 16 and any particulate vitrifiable binder material 18, to be transferred to the first binder. Depending on the type of first binder used, this tacky state can be achieved in a variety of ways.

When the first binder is formed from a solvent-based mixture containing a polymer, oligomer, monomer or combinations thereof, a tacky state may be inherent in the mixture. If not, it may be achieved by removing at least some of the solvent and, if required, at least partially curing the polymer, oligomer or monomer.

When the first binder is formed from a substantially solvent-free mixture containing a liquid polymer, oligomer, monomer or combinations thereof, the tacky state may be inherent in the mixture as well. If not, a tacky state may be achieved by heating or cooling the mixture or may be achieved by at least partially curing the polymer, oligomer, monomer or combinations thereof.

When the first binder is a particulate vitrifiable binder material so that the vitrifiable binder functions as the make coat, a tacky state may be achieved by heating the particulate vitrifiable binder material to a temperature near, at or above its glass transition (T_{g}) temperature and/or melting point to enable sufficient tack to develop. Advantageously, in this case, a uniform coating of the first binder on a rigid substrate (such as substrate 20 in FIG. 2) can be facilitated by heating the particulate vitrifiable binder material to a temperature above its T_{g} temperature and/or melting point causing a phase transition from the solid to liquid state. The heating can be done, for example, by placing the rigid substrate containing the particulate vitrifiable binder into an oven or other heating devices. Once in the liquid state, a uniform coating of the particulate vitrifiable binder material can be formed by techniques know to those skilled in the art, such as, for example, by manually spreading the now liquid material. Thus, in this particular case, the particulate vitrifiable binder material used as a first binder 22 (i.e., the make coat) may be the same or different from particulate vitrifiable binder material 18 (i.e., the size coat).

In one embodiment of the present invention, after abrasive particles 16 and any particulate vitrifiable binder material 18, if used, are transferred to the first binder 22, it may be a least partially cured and/or partially vitrified, forming a solid or substantially solid (in the case of partial cure or partial vitrification) first binder. The term “vitrified” means generally that the binder has been converted into a glassy material, optionally by using a light source, such as a visible light or an ultraviolet light source. With a solid first binder, the abrasive particles are rigidly held therein, being substantially fixed in place, forming a fixed abrasive article. When the first binder is thermoplastic resin, it can be vitrified by cooling below its melting point and/or T_{g} temperature. When the first binder is a solvent-based mixture containing a polymer, oligomer, monomer or combinations thereof, it can be transformed to the solid state by removal of a majority of the solvent and/or by various methods of curing known to those skilled in the art. When the first binder is a substantially solvent-free mixture containing liquid polymer, oligomer, monomer or combinations thereof, it can be transformed to the solid state by various methods of curing known to those skilled in the art.

In another embodiment of the present disclosure, after abrasive particles 16 and any particulate vitrifiable binder material 18, if used, are transferred to the first binder 22, it remains in a liquid state forming a non-fixed abrasive article. The viscosity of the first binder in the liquid state may be adjusted to the desired level by a variety of methods including, for example, heating, cooling, partially curing, and removing solvent (if present). In these embodiments, during use as an abrasive article, the abrasive particles are substantially free to move within the first binder. Preferably, when the abrasive article comprises a resinous binder in the liquid state forming a non-fixed abrasive article, no additional size coat or supersize coat is required.

In still another embodiment of the present disclosure, optional second binder (the size coat) and optional third binder (the super-size coat) may be applied to the first binder and the abrasive particles. The first binder can be in the solid state or liquid state during the size coat and/or super size coat process step. Preferably, the first binder is in the solid state. The size coat and/or super size coat can be applied by known coating techniques. Compositions of the abrasive particles, make coat, size coat, and super-size coat are discussed in below in detail.

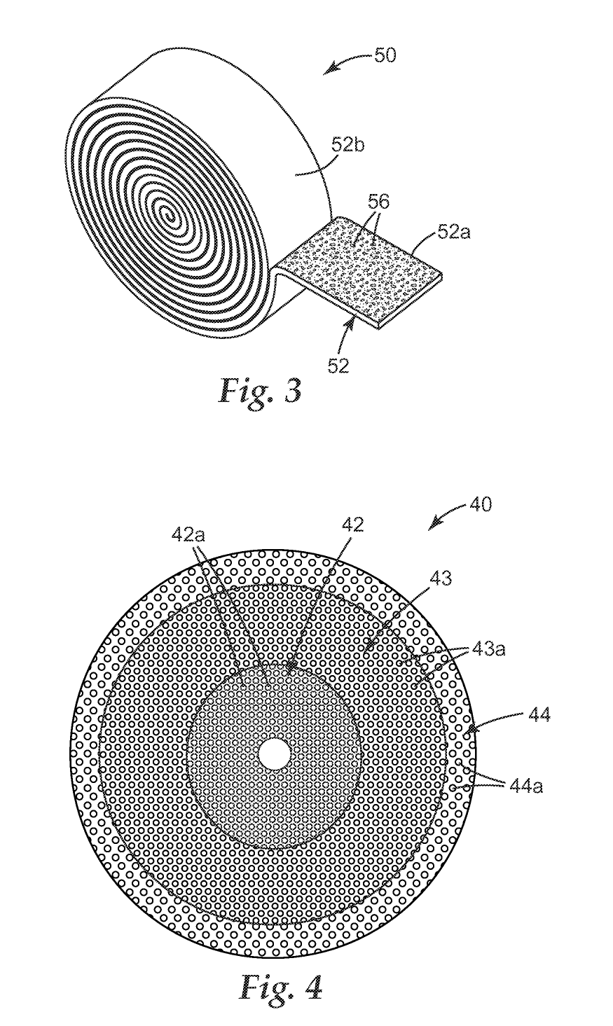

FIG. 3 shows a perspective view a roll of transfer article 50 according to one aspect of the present disclosure, similar to that of a roll of tape. The roll of transfer article may be subsequently converted into sheets and discs or may be in the form of a sheet or disc. The transfer articles of the present disclosure may be used to modify a substrate, both rigid and flexible with unique surface distribution of abrasive particles.

The roll of transfer article includes a single liner 52 having opposing first surface and second surface 52b, with a release coating (not shown) disposed on the first surface. Abrasive particles 56 and optional vitrifiable binder material (not shown) are disposed on the first surface. Optionally, a second release coating (not shown) is also disposed on the first surface 52a of the liner, the second release coating having a lower release value than the first release coating thereby promoting the unwinding of the roll and minimizing if not eliminating the possibility of the abrasive particles (and any vitrifiable binder material if used) remaining with the second surface 52b of the liner.

Another embodiment of the present disclosure includes multiple layers of release liner and abrasive particles. For example, a transfer article may comprise a first liner having a first and second surface. A first layer of abrasive particles is disposed on the first surface of the first liner. A second liner, having a first and second surface, is disposed on the layer of abrasive particles such that the first surface of the second liner is in contact with the abrasive particles. Thus, the abrasive particles are sandwiched between the first and second liners. A second layer of metal particles is disposed on the second surface of the second liner. Optionally a third liner, having a first and second surface, is in contact with the second layer of abrasive particles. The number of layers of liners and the number of layers of abrasive particles can be selected based on the desired end use. The first, second, third and any additional liners may be the same or may be different. Similarly, the first, second and any additional layers of abrasive particles may be the same or may be different.

### Materials for the First and Optional Second Liner

The type of release liner suitable for use in the present disclosure is not limited, so long as the liner can cause an electrostatic attraction to or electrostatic adhesion between it and the abrasive particles thereby allowing the abrasive particles to remain or cling to the liner. As discussed with reference to the drawings above, the liner has a release coating disposed on its first surface.

In one embodiment, the liner is a flexible backing Exemplary flexible backings include densified Kraft paper (such as those commercially available from Loparex North America, Willowbrook, Ill.), poly-coated paper, and polymeric film. Suitable polymeric film includes polyester, polycarbonate, polypropylene, polyethylene, cellulose, polyamide, polyimide, polysilicone, and polytetrafluoroethylene.

In one embodiment, the release coating of the liner has a release value of less than about 700 gram per inch. Various test method can be used to measure this release value, such as for example ASTM D3330/D3330M-04.

In another embodiment, the release coating of the liner is fluorine containing material, a silicon containing material, a fluoropolymer, a silicone polymer, or a poly (meth)acrylate ester derived from a monomer comprising an alkyl (meth)acrylate having an alkyl group 12 to 30 carbon atoms. In one embodiment, the alkyl group can be branched. Illustrative examples of useful fluoropolymers and silicone polymers can be found in U.S. Pat. Nos. 4,472,480; 4,567,073; and 4,614,667. Illustrative example of a useful poly (meth)acrylate ester can be found in U.S. Patent Application Publication No. US 2005/118352.

In one embodiment, a first surface of the liner on which the abrasive particles are to be disposed may be textured so that at least one plane of the first surface of the liner is higher than another plane. The textured surface may be patterned or random. The highest plane or planes of the textured surface may be designated as the “delivery plane” because the highest plane or planes will deliver the metal particles to a substrate. The lower plane or planes may be designated as “recessed planes.”

### Abrasive Particles

Suitable abrasive particles that can be used in the present disclosure include fused aluminum oxide, heat treated aluminum oxide, white fused aluminum oxide, black silicon carbide, green silicon carbide, titanium diboride, boron carbide, tungsten carbide, titanium carbide, diamond (both natural and synthetic), silica, iron oxide, chromia, ceria, zirconia, titania, silicates, tin oxide, cubic boron nitride, garnet, fused alumina zirconia, sol gel abrasive particles and the like. Examples of sol gel abrasive particles can be found in U.S. Pat. Nos. 4,314,827 (Leitheiser et al.); 4,623,364 (Cottringer et al); 4,744,802 (Schwabel); 4,770,671 (Monroe et al.); and 4,881,951 (Wood et al.).

As used herein, the term abrasive particle also encompasses single abrasive particles bonded together with a polymer, a ceramic, a metal or a glass to form abrasive agglomerates. The term abrasive agglomerate includes, but is not limited to, abrasive/silicon oxide agglomerates that may or may not have the silicon oxide densified by an annealing step at elevated temperatures. Abrasive agglomerates are further described in U.S. Pat. Nos. 4,311,489 (Kressner); 4,652,275 (Bloecher et al.); 4,799,939 (Bloecher et al.); 5,500,273 (Holmes et al.); 6,645,624 (Adefris et al.); and 7,044,835 (Mujumdar et al.). Alternatively, the abrasive particles may be bonded together by inter-particle attractive forces as describe in U.S. Pat. No. 5,201,916 (Berg, et al.). Preferred abrasive agglomerates include agglomerates having diamond as the abrasive particle and silicon oxide as the bonding component. When an agglomerate is use, the size of the single abrasive particle contained within the agglomerate can range from 0.1 to 50 micrometer (μm) (0.0039 to 2.0 mils), preferably from 0.2 to 20 μm (0.0079 to 0.79 mils) and most preferably between 0.5 to 5 μm (0.020 to 0.20 mils).

The average particle size of the abrasive particles is less than 150 μm (5.9 mils), preferably less than 100 μm (3.9 mils), and most preferably less than 50 μm (2.0 mils). The size of the abrasive particle is typically specified to be its longest dimension. Typically, there will be a range distribution of particle sizes. In some instances it is preferred that the particle size distribution be tightly controlled such that the resulting abrasive article provides a consistent surface finish on the work piece being abraded.

The abrasive particle may also have a shape associated with it. Examples of such shapes include rods, triangles, pyramids, cones, solid spheres, hollow spheres and the like. Alternatively, the abrasive particle may be randomly shaped. Abrasive particles disposed on a liner may be of the same or different composition; may be the same size, varying size, and may be of the same shape or different shapes.

Yet another useful type of abrasive particle is a metal-based abrasive particle having a substantially spheroid metal containing matrix having a circumference and a super-abrasive materials having an average diameter of less than 8 μm at least partially embedded in the circumference of the metal containing matrix. Such abrasive particles can be made by charging into a vessel, metal-containing matrix (predominantly spheroids), super-abrasive particles, and grinding media. The vessel is then milled for a period of time, typically at room temperature. It is believed that the milling process forces the super abrasive material to penetrate into, attach to, and protrude from the metal containing matrix. The circumference of the metal containing matrix changes from pure metal or metal alloy to a composite of super abrasive and metal or metal alloy. The subsurface of the metal containing matrix near the circumference also contains the super abrasive material, which would be considered as being embedded in the metal containing matrix. This metal-based abrasive particle is disclosed in assignee's co-pending PCT International Publication No. WO 2010/002725.

Abrasive particles can be coated with materials to provide the particles with desired characteristics. For example, materials applied to the surface of an abrasive particle have been shown to improve the adhesion between the abrasive particle and the polymer. Additionally, a material applied to the surface of an abrasive particle may improve the adhesion of the abrasive particles in the softened particulate curable binder material. Alternatively, surface coatings can alter and improve the cutting characteristics of the resulting abrasive particle. Such surface coatings are described, for example, in U.S. Pat. Nos. 5,011,508 (Wald et al.); 3,041,156 (Rowse et al.); 5,009,675 (Kunz et al.); 4,997,461 (Markhoff-Matheny et al.); 5,213,591 (Celikkaya et al.); 5,085,671 (Martin et al.) and 5,042,991 (Kunz et al.).

### Resin Binder Based Make Coat and Size Coat

Materials that are useful as the first binder (the make coat) are also useful as the second binder (the size coat).

Examples of suitable first and or second binders include thermosetting resins, such as phenolic resins, aminoplast resins having pendant α,β-unsaturated carbonyl groups, urethane resins, acrylated urethane resins, epoxy resins, acrylated epoxy resins, ethylenically-unsaturated resins, acrylated isocyanurate resins, urea-formaldehyde resins, isocyanurate resins, bismaleimide resins, fluorene modified epoxy resins, and mixtures thereof.

Suitable epoxy resins have an oxirane ring and are polymerized by the ring opening. Such epoxide resins include monomeric epoxy resins and polymeric epoxy resins. These resins can vary greatly in the nature of their backbones and substituent groups. For example, the backbone may be of any type normally associated with epoxy resins and substituent groups thereon can be any group free of an active hydrogen atom that is reactive with an oxirane ring at room temperature. Representative examples of acceptable substituent groups include halogens, ester groups, ether groups, sulfonate groups, siloxane groups, nitro groups and phosphate groups. Examples of some preferred epoxy resins include 2,2-bis[4-(2,3-epoxy-propoxy)phenyl]propane (diglycidyl ether of bisphenol) and resins which are commercially available from Shell Chemical Co., Houston, Tex., under the trade designations EPON 828, EPON 1004, and EPON 1001F; and from Dow Chemical Co., Midland, Mich., under the trade designations DER 331, DER 332, and DER 334. Other suitable epoxy resins include glycidyl ethers of phenol formaldehyde novolac (from Dow Chemical Co.) under the trade designations DEN 431 and DEN 438.

Phenolic resins are used as resinous binders in abrasive article because of their thermal properties, availability, cost and ease of handling. There are two suitable types of phenolic resins, resole and novolac. Resole phenolic resins have a molar ratio of formaldehyde to phenol, of greater than or equal to 1:1, typically between 1.5:1.0 to 3.0:1.0. Novolac resins have a molar ratio of formaldehyde to phenol of less than one to one. Suitable examples of phenolic resins include those commercially available from Occidental Chemical Corp., Tonawanda, N.Y., under the trade designations DUREZ and VARCUM; from Monsanto Co., St. Louis, Mo., under the trade designation RESINOX; and from Ashland Chemical Inc., Columbus, Ohio, under the trade designations AROFENE and AROTAP.

The aminoplast resins which can be used as resinous binders have at least one pendant α,β-unsaturated carbonyl group per molecule or oligomer. These materials are further described in U.S. Pat. Nos. 4,903,440 (Larson et al.) and 5,236,472 (Kirk et al.).

Suitable ethylenically-unsaturated resins include both monomeric and polymeric compounds that contain atoms of carbon, hydrogen and oxygen, and optionally, nitrogen and the halogens. Oxygen or nitrogen atoms or both are generally present in ether, ester, urethane, amide, and urea groups. The ethylenically-unsaturated compounds preferably have a molecular weight of less than about 4,000 and are preferably esters made from the reaction of compounds containing aliphatic monohydroxy groups or aliphatic polyhydroxy groups and unsaturated carboxylic acids, such as acrylic acid, methacrylic acid, itaconic acid, crotonic acid, isocrotonic acid, maleic acid, and the like. Representative examples of ethylenically-unsaturated resins include those made by polymerizing methyl methacrylate, ethyl methacrylate, styrene, divinylbenzene, vinyl toluene, ethylene glycol diacrylate, ethylene glycol dimethacrylate, hexanediol diacrylate, triethylene glycol diacrylate, trimethylolpropane triacrylate, glycerol triacrylate, pentaerythritol triacrylate, pentaerythritol trimethacrylate, pentaerythritol tetraacrylate, or pentaerythritol tetramethacrylate, and mixtures thereof. Other ethylenically-unsaturated resins include those of polymerized monoallyl, polyallyl, and polymethallyl esters and amides of carboxylic acids, such as diallyl phthalate, diallyl adipate, and N,N-diallyladipamide. Still other polymerizable nitrogen-containing compounds include tris(2-acryloxyethyl)isocyanurate, 1,3,5-tri(2-methacryl-oxyethyl)-s-triazine, acrylamide, methylacrylamide, N-methylacrylamide, N,N-dimethyl-acrylamide, N-vinylpyrrolidone, and N-vinylpiperidone.

Acrylated urethanes are diacrylate esters of hydroxy terminated isocyanate extended polyesters or polyethers. Examples of acrylated urethanes which can be used in the make coats of the present invention include those commercially available from Radcure Specialties, Inc., Atlanta, Ga., under the trade designations, UVITHANE 782, CMD 6600, CMD 8400, and CMD 8805. Acrylated epoxies which can be used in the make coats are diacrylate esters of epoxy resins, such as the diacrylate esters of bisphenol A epoxy resin. Examples of acrylated epoxies include those available from Radcure Specialties, under the trade designations, CMD 3500, CMD 3600, and CMD 3700.

Bismaleimide resins which also can be used as resinous binder are further described in U.S. Pat. No. 5,314,513 (Miller et al.).

At least one of first and second binder can be system that contains a ternary photoinitiator system allowing for photocuring as disclosed in U.S. Pat. No. 4,735,632 (Oxman et al.). Other suitable first and second binders are disclosed in U.S. Pat. Nos. 5,580,647 (Larson et al.) and 6,372,336 B1 (Clausen).

At least one of the first and second binder can also contain optional additives, such as, for example, fillers (including grinding aids), fibers, lubricants, wetting agents, thixotropic materials, surfactants, pigments, dyes, antistatic agents, coupling agents, plasticizers, and suspending agents. The amounts of these materials are selected to provide the properties desired.

### Particulate Binder Based Make Coat, Size Coat, and Supersize Coat

The first binder, second binder and optional third binder can be a particulate vitrifiable binder material that is a solid at room temperature (23° C.). Vitrifiable in this context means to become a solid either (i) through the curing (such as visible light cure or ultraviolet light cure) of a thermosetting liquid composition or (ii) by the cooling of a thermoplastic material, which can be semi-crystalline or non-crystalline. In some aspects, the particulate vitrifiable binder material may be mixed with abrasive particles, particularly when used as a size coat for a rigid substrate previously coated with a make coat. The particulate vitrifiable binder material preferably comprises organic vitrifiable polymer particles. The particulate vitrifiable polymers preferably are capable of softening on heating to provide a vitrifiable liquid capable of flowing sufficiently so as to be able to wet either an abrasive particle surface or the surface of an adjacent vitrifiable binder particle.

Suitable particulate vitrifiable binder material is capable of providing satisfactory abrasive particle bonding and/or bonding to the make coat, the size coat or rigid substrate by being activated or rendered tacky at a temperature, which avoids causing heat damage or disfiguration to the rigid substrate to which it adhered. The particulate vitrifiable binder materials meeting these criteria can be selected from among certain thermosetting particle materials, thermoplastic particle materials and mixtures of thermosetting and thermoplastic particle materials, as described herein.

The thermosetting particle systems involve particles made of a temperature-activated thermosetting resin. Such particles are used in a solid granular or powder form. The initial effect of a temperature rise above the T_{g} temperature is a softening of the material into a flowable fluid-like state. This change in physical state allows the resin particles to mutually wet or contact the substrate, make coat, size coat and/or abrasive particles. Prolonged exposure to a sufficiently high temperature triggers a chemical reaction which forms a cross-linked three-dimensional molecular network. The solidified (cured) resin particle bonds abrasive particles to the abrasive article. Useful particulate vitrifiable binder materials are selected from the group consisting of phenolic resins, phenoxy resins, polyester resins, copolyester resins, polyurethane resins, polyamide resins and mixtures thereof. Useful temperature-activated thermosetting systems include formaldehyde-containing resins, such as phenol formaldehyde, novolac phenolics and especially those with added crosslinking agent (e.g., hexamethylenetetramine), phenoplasts, and aminoplasts; unsaturated polyester resins; vinyl ester resins; alkyd resins, allyl resins; furan resins; epoxies; polyurethanes; cyanate esters; and polyimides. Useful thermosetting resins include the thermosetting powders disclosed, for example, in U.S. Pat. Nos. 5,872,192 (Kaplan et al.) and 5,786,430 (Kaplan et al.).

In the use of heat-activated thermosetting fusible powders, the particulate vitrifiable binder material is heated to at least its cure temperature to optimize the substrate and abrasive bonding. To prevent heat damage or distortion to the make or size coat, the cure temperature of the fusible thermosetting particle preferably will be below the melting point, and preferably below the T_{g} temperature, of these constituents.

Useful thermoplastic particulate vitrifiable binder materials include polyolefin resins such as polyethylene and polypropylene; polyester and copolyester resins; vinyl resins such as poly(vinyl chloride) and vinyl chloride-vinyl acetate copolymers; polyvinyl butyral; cellulose acetate; acrylic resins including polyacrylic and acrylic copolymers such as acrylonitrile-styrene copolymers; and polyamides (e.g., hexamethylene adipamide, polycaprolactum), and copolyamides.

In the case of semi-crystalline thermoplastic binder particles (e.g., polyolefins, polyesters, polyamides, polycaprolactum), it is preferred to heat the binder particles to at least their melting point whereupon the powder becomes molten to form a flowable fluid. Where noncrystallizing thermoplastics are used as the fusible particles of the bonding agent (e.g., vinyl resins, acrylic resins), the particles preferably are heated above the T_{g} temperature and rubbery region until the fluid flow region is achieved.

Mixtures of the above thermosetting and thermoplastic particle materials may also be used in the invention. Furthermore, the size of the particulate vitrifiable binder material is not particularly limited. In general, the average diameter of the particle is less than 1000 μm (0.039 in), preferably less than 500 μm (0.020 in), and more preferably less than 100 μm (0.0039 in). Generally, the smaller the diameter particles, the more efficient they may be rendered flowable because the surface area of the particles will increase as the materials are more finely divided.

The amount of particulate vitrifiable binder material used in the particulate vitrifiable binder-abrasive particle mixture (i.e., the “powder) generally will be in the range from 5 to 99 wt % particulate vitrifiable binder material, with the remainder 1 to 95 wt % comprising abrasive particles and optional fillers. Preferred proportions of the components in the mixture are 10 to 90 wt % abrasive particles and 90 to 10 wt % particulate vitrifiable binder material, and more preferably 50 to 85 wt % abrasive particles and 50 to 15 wt % particulate vitrifiable binder material.

The particulate vitrifiable binder material may include one or more optional additives selected from the group consisting of grinding aids, fillers, wetting agents, chemical blowing agents, surfactants, pigments, coupling agents, dyes, initiators, curing agents, energy receptors, and mixtures thereof. The optional additives may also be selected from the group consisting of potassium fluoroborate, lithium stearate, glass bubbles, inflatable bubbles, glass beads, cryolite, polyurethane particles, polysiloxane gum, polymeric particles, solid waxes, liquid waxes and mixtures thereof. Optional additives may be included to control particulate vitrifiable binder material porosity and erosion characteristics.

### Rigid Substrate

The term “rigid” describes a substrate that is at least self-supporting, i.e., it does not substantially deform under its own weight. By rigid, it is not meant that the substrate is absolutely inflexible. Rigid substrates may be deformed or bent under an applied load but offer very low compressibility. In one embodiment, the rigid substrates comprise materials having a modulus of rigidity of 1×10⁶ pound per square inch (psi) (7×10⁴ kg/cm²) or greater. In another embodiment, the rigid substrates comprise material having a modulus of rigidity of 10×10⁶ psi (7×10⁵ kg/cm²) or greater.

Suitable materials that can function as the rigid substrate include metals, metal alloys, metal-matrix composites, metalized plastics, inorganic glasses and vitrified organic resins, formed ceramics, and polymer matrix reinforced composites.

In one embodiment, the rigid substrate is substantially flat such that the height difference between its opposing first and second surfaces is less than 10 μm at any two points thereon. In another embodiment, the rigid substrate has a precise, non-flat geometry, such those that can be used for polishing lenses.

Yet another embodiment includes a modified substrate comprising a rigid substrate having a first and a second surface, a first binder on the first surface of the substrate, and a layer of abrasive particles disposed in the first binder, wherein the layer comprises at least two concentric regions on the first binder. The term “concentric” refers to a sharing of the same center, axis or origin, i.e., the center of the substrate. Suitable shapes for concentric regions include, but are not limited to, circles, squares and stars. Each concentric region varies in some way from another concentric region so that each concentric region comprises abrasive particles having a feature which differs from a feature of abrasive particles of any other concentric region. For example, a concentric region may vary from another concentric region by the areal density (bearing area) or the abrasive particles, the wear resistance, the type, the size, the shape and or the placement (random or uniformly spaced) of the abrasive particles.

In addition, within a region, the placement or location of abrasive particles may be such that the particles are uniformly spaced or randomly spaced. Also, the type and or shape of abrasive particles may be varied within a region and yet still be different from another region.

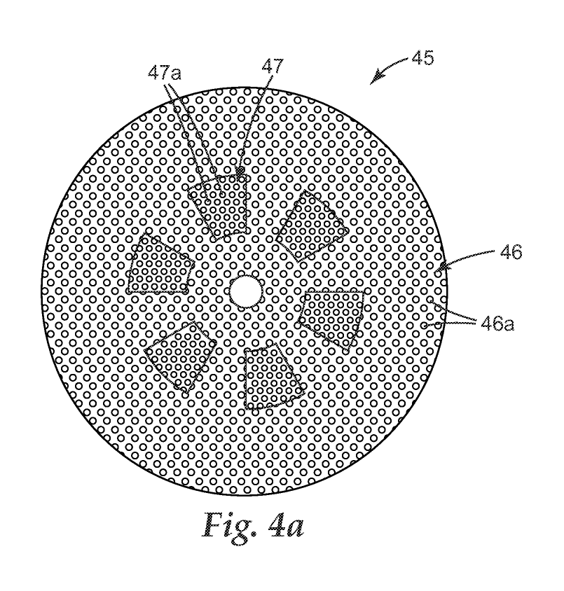

FIG. 4 depicts an exemplary abrasive particle modified substrate 40 with three concentric regions 41, 42, and 43 and comprises metal particles 41a, 42a, and 43a, respectively. Each of the regions 41, 42, and 43 has a different areal density or wear resistance.

Another exemplary abrasive modified substrate is shown in FIG. 4a. FIG. 4a depicts an exemplary abrasive article modified substrate 45 with a continuous region 46, with abrasive particles 46a, and a discontinuous region 47, with abrasive particles 47a. Region 46 and region 47, as shown, differ in terms of areal density of particles 46a and 47a, respectively. In another embodiment, a layer of abrasive particles may comprise at least one continuous region and at least one discontinuous region within the at least one continuous region where the abrasive particles of the at least one continuous region varies, as described above, from the abrasive particles of the at least one discontinuous region.

The difference between concentric regions may be selected based on the intended use of a modified substrate. For example, the area or size of a particular concentric region as well as the areal density or wear resistance may be selected based on the intended use of the substrate modified with abrasive particles.

Each patent and patent application recited herein are incorporated by reference in its entirety.

### EXAMPLES

### Example 1

A first abrasive transfer article was made as follows.

A 25 inch (63.5 cm) square sheet of 3M™ Secondary Liner 4935 (available from 3M Company, St. Paul, Minn.) has a first side containing a release coating thereon and an opposing second side. The liner was taped to a 25 inch (63.5 cm) square 2.0 mm thick aluminum plate, with the first, release side exposed. The aluminum plate with liner was placed on a substantially horizontal work surface. About 2 g of abrasive diamond beads having average diameter of less than 40 micrometer (μm), were place in a line across one edge of the liner. The edge of the aluminum plate having the abrasive beads was lifted up at an angle from the horizontal work surface and the back side of the aluminum plate was tapped, causing the beads to roll down and coat the liner. Abrasive diamond beads were supplied from Tomei Corporation of America, Cedar Park, Tex. Additional abrasive particles were added to substantially cover the entire exposed surface area of the first release side of the first liner. Thereafter, the aluminum sheet with the attached and now abrasive particle coated liner was held nearly vertically and tapped to remove excess abrasive particles. The aluminum plate was replaced on the horizontal work surface.

A second 3M™ Secondary Liner 4935 liner has a first side containing a release coating thereon and an opposing second side. The second liner was applied to the abrasive particles such that the first release side of the second liner contacted with the abrasive particles. Pressure was then manually applied to the abrasive particles by rolling the second surface of the second liner using, e.g., a hand roller. It is believed that this manual rolling process aligns the largest diameter abrasive particles into a substantially uniform layer of, perhaps even a monolayer, particles disposed in between the first and second liner.

### Example 2

A second transfer abrasive article was made as follows.

A substantially clear acrylic cylinder having a 7 inch (17.8 cm) inside diameter (ID) with a 19 inch (48.3 cm) length was lined with a first 19 by 22 inch (48.3 by 55.9 cm) sheet of 3M™ Secondary Liner 4935 as used in Example 1. The cylinder has a central axis that runs along its length. The liner was positioned with its first release side facing the center of the tube and its second side positioned against the cylinder's ID.

The lined cylinder was placed on a substantially horizontal work surface such that the cylinder's central axis laid substantially parallel to the work surface. Thereafter, two to three grams of abrasive diamond particles of Example 1 were placed on the liner near the first end of the cylinder. The first end of the cylinder was elevated 1 inch (2.54 cm) from horizontal work surface. While the first end was elevated, the cylinder was rolled in one direction and tapped to promote the abrasive particles to travel down the cylinder's length so as to substantially cover the entire exposed surface area of the first release side of the liner.

The abrasive coated liner was removed from the cylinder and was placed horizontally with the abrasive particles exposed such that the second surface of the first liner contacted an aluminum plate.

A second 3M™ Secondary liner was applied to the exposed surface of the abrasive particle as in Example 1 and thereafter manual pressure was applied, as in Example 1.

### Example 3

A third transfer abrasive article was made as in Example 2 except that instead of using only abrasive diamond particles, a powder containing polyester resin binder and abrasive diamond particles was used.

The powder was made by combining 1 part polyester resin binder (commercially available as product number GRILTEX D1644E P1-P3 from EMS-CHEMIE North America, Inc. Sumter, S.C.) with 2 parts abrasive diamond in a plastic container. The container was sealed and the powder was mixed overnight on a conventional roller mill. Prior to mixing with abrasive diamond particles, using standard techniques, the polyester powder was sieved to a particle size of less than 40 μm. The polyester resin binder had a reported melting point of 60° C.

### Example 4

A first rigid substrate containing abrasive particles was made as follows.

A first binder (sometimes referred to as a “make coat”) was prepared by blending 50 parts of methyl ethyl ketone (MEK) with 50 parts of SCOTCHWELD 1838L, a two part liquid epoxy available from the 3M Company, St. Paul, Minn.

A rigid, metal alloy-based, annular platen with a 13 inch (33 cm) outside diameter and an 8 inch (20.3 cm) inside diameter containing a tin alloy (see e.g., M. Jiang et. al., Applied Physics A 77, 923-932 (2003)) was coated with 1.2 gram of make coat. The binder was manually rolled onto the platen using, e.g., a rubber roller, until the first binder appeared visually uniform. The working time of the epoxy-based make coat was about one hour. A temporary sheet of 3M™ Secondary Liner 4935 as in Example 1 was provided. The sheet was disposed on the first binder to keep it substantially particulate-free, to insure nearly complete wet out of the first binder on the metal platen surface, and perhaps to enable the binder to flow to a substantially uniform thickness, once the solvent is removed. Some solvent may have evaporated during manual rolling step. After 30 minutes, the first binder viscosity had increased. The temporary liner was removed by peeling it off the metal platen. A portion of the first binder remained on the platen and a portion remained on the liner.

The first transfer abrasive article of Example 1 was then provided. The second liner of the first abrasive particle was removed. A small fraction of the abrasive particles remaining adhered to the first surface of the second liner leaving a majority of the abrasive particles attached electrostatically to the first surface of the first liner.

The first liner with the abrasive particles attached thereon was disposed onto the make coat covered metal platen with the abrasive particles contacting the make coat. In order to provide good contact between the abrasive particles and make coat, pressure was manually applied to the second side of the first liner, using, e.g., a rubber roller. The first liner of the abrasive transfer article of Example 1 was removed, leaving the majority of the abrasive particles in the make coat.

To increase the number of abrasive particles in the make coat, another transfer abrasive article of Example 1 was used and the procedure in the preceding two paragraphs was repeated. A second temporary sheet of 3M™ Secondary Liner 4935 was applied to the surface of the platen, release side down, making contact with the abrasive articles. Pressure was applied manually to a second surface of the second temporary sheet to force the abrasive particles into the make coat. The first binder, now loaded with a plurality of abrasive particles, was allowed to cure at room temperature for two hours and then placed in an air circulating oven at 74° C. for three hours. The platen was removed and allowed to cool to room temperature forming an abrasive article. The oven drying can occur with or without the second temporary liner protecting the platen.

### Example 5

A second rigid substrate containing abrasive particles was made according to Example 4, as modified below by adding a second binder.

A second binder solution (sometimes referred to as a “size coat”) was made as follows. To a container was added 2.6 grams cyclohexanone, 0.057 gram MRS (MONDUR isocyanate from Bayer Material Science LLC, Pittsburg, Pa.), 0.12 gram of a polycaprolactone-polyurethane polymer, product number RD 676 (available from 3M Company), and 0.21 gram phenoxy resin, product number MS 3165 phenoxy (available from 3M Company).

Using a pipette, 3 gram of size coat solution was applied to the abrasive particle covered platen. The solution was manually spread with a rubber roller with effort made to roll puddles of the size coat off the sides of the platen. Light hand pressure was applied. The size coated, abrasive platen was place an air circulating oven at 74° C. for 3 hours. The platen was removed from the oven and allowed to cool at room.

### Example 6

A third rigid substrate containing abrasive particles was made according to Example 5, as modified below by adding a phenolic-based second binder.

The phenolic-based second binder was made by mixing 3 grams of phenolic resin, product number R 23155 (available from 3M Company) with 4 grams of a diluent made with 50 parts water and 50 parts isopropylalcohol.

This phenolic-based size coat was applied to the abrasive particle covered platen and dried and cured as in Example 5.

### Example 7

A fourth rigid substrate containing abrasive particles was made as follows.

A first binder (i.e., make coat) was made by combining 0.5 gram SCOTCHWELD 1838L with 0.1 gram of 10 μm (average diameter) methyl methacrylate beads, product number MX1000 from Soken Chemical, Tokyo, Japan. The make coat was then applied to a surface of a rigid, metal alloy-based, annular platen as in Example 4. It is believed that the methyl methacrylate beads aid in spreading of the first binder to promote substantially complete coverage of the platen at a uniform binder thickness of about 10 μm.

Abrasive transfer article 2 made according to Example 2 was provided. The abrasive particles were transferred to the make coat coated platen and cured as in Example 4.

### Example 8

A fifth rigid substrate containing abrasive particles was made as follows.

A first binder was made according to Example 7.

Abrasive transfer article 3 made according to Example 3 was provided. The abrasive particles were transferred to the make coat coated platen and cured as in Example 4.

What is claimed is:

1. A transfer article useful for making an abrasive article, the transfer article comprising:
a first liner having opposing first and second surfaces, the first surface having a release value of less than about 700 gram per inch per ASTM D3330/D3330M-04; and
a powder comprising abrasive particles disposed on the first surface of the first liner.

2. The transfer article of claim 1 further comprising a second liner having opposing first and second surfaces, the first surface of the second liner having a release value of less than about 700 gram per inch as measured according to ASTM D3330/D3330M-04, the second liner disposed on the abrasive particles such that the first surface of the second liner is in contact with the abrasive particles.

3. The transfer article of claim 2 wherein at least one of the first liner and second liner comprise a flexible backing and a release coating disposed on at least one of the first and second surfaces of the first and second liner, the release coating comprising a fluorine containing material, a silicon containing material, a fluoropolymer, a silicone polymer or a poly (meth)acrylate ester derived from a monomer comprising an alkyl (meth)acrylate having an alkyl group having 12 to 30 carbon atoms.

4. The transfer article of claim 2 wherein the flexible backing is selected from the group consisting of densified kraft paper, polycoated paper, and polymeric film.

5. The transfer article of claim 4 wherein the polymeric film is selected from the group consisting of polyester, polycarbonate, polypropylene, polyethylene, cellulose, polyamide, polyimide, polysilicone, and polytetrafluoroethylene.

6. The transfer article of claim 1 wherein the abrasive particles are selected from the group consisting of fused aluminum oxide, heat treated aluminum oxide, white fused aluminum oxide, black silicon carbide, green silicon carbide, titanium diboride, boron carbide, tungsten carbide, titanium carbide, diamond, silica, iron oxide, chromia, ceria, zirconia, titania, silicates, tin oxide, cubic boron nitride, garnet, fused alumina zirconia, sol gel abrasive particles, abrasive agglomerates, metal-based particulates, and combinations thereof.

7. The transfer article of claim 6 wherein the abrasive agglomerates comprise diamond and silicon oxide.

8. The transfer article of claim 1 wherein the particles have an average size of less than about 150 micrometer.

9. The transfer article of claim 1 wherein the powder further comprises at least one of thermoplastic or thermosetting resin particles.

10. The transfer article of claim 9 wherein the thermoplastic resin particles have a melting point greater than about 60° C.

11. The transfer article of claim 9 wherein the thermoplastic resin particles are selected from the group consisting of polyester and epoxy.

12. The transfer article of claim 9 wherein the thermosetting resin particles are selected from the group consisting of phenolic, epoxy, urethane, ethylenically unsaturated resins, and combinations thereof.

13. The transfer article of claim 2 wherein at least one of the first and second liner is textured.

14. A method of making a fixed abrasive article comprising the steps of:
providing a rigid substrate having opposing first and second surfaces;
coating a first binder on the first surface of the rigid substrate;
providing a transfer article comprising:
a first liner having opposing first and second surfaces, the first surface having a release value of less than about 700 gram per inch per ASTM D3330/D3330M-04; and
a powder comprising abrasive particles disposed on the first surface of the first liner;
disposing the first liner on the first binder coated to the first surface of the rigid substrate such that the abrasive particles contact the first binder;
removing the first liner from the rigid substrate; and
curing the first binder thereby securing the abrasive particles to the rigid substrate.

15. The method of claim 14 wherein the transfer article further comprises a second liner having opposing first and second surfaces, the first surface of the second liner having a release value of less than about 700 gram per inch as measured according to ASTM D3330/D3330M-04, the second liner disposed on the abrasive particles such that the first side of the second liner is in contact with the abrasive particles.

16. The method of claim 15 further comprising the step of removing the second liner from the transfer article leaving abrasive particles adhered to the first surface of the first liner prior to the step of disposing the first liner on the first binder.

17. The method of claim 14 wherein the first binder is at least partially cured prior to disposing the first liner and the associated abrasive particles thereon.

18. The method of claim 14 wherein the first binder is substantially solvent free.

19. The method of claim 14 further comprising a step of coating a second binder on the first binder after the curing the first binder step.

20. The method of claim 14 wherein the rigid substrate is selected from the group consisting of metals, metal alloys, metal-matrix composites, metalized plastics, and polymer matrix reinforced composites.

21. The method of claim 14 wherein rigid substrate is substantially flat such that the height difference between the opposing first and second surfaces is less than 10 micrometer from any two points on the substrate.

22. The method of claim 14 wherein the rigid substrate has a precise, non-flat geometry.

23. The method of claim 14 wherein the rigid substrate is a hollow cylindrical tube having an inside diameter and where at least the first binder and the abrasive particles are attached to the inside diameter.

24. The method of claim 14 wherein the abrasive particles are selected from the group consisting of fused aluminum oxide, heat treated aluminum oxide, white fused aluminum oxide, black silicon carbide, green silicon carbide, titanium diboride, boron carbide, tungsten carbide, titanium carbide, diamond, silica, iron oxide, chromia, ceria, zirconia, titania, silicates, tin oxide, cubic boron nitride, garnet, fused alumina zirconia, sol gel abrasive particles, abrasive agglomerates, metal-based abrasive particles, and combinations thereof.

25. The method of claim 24 wherein the abrasive agglomerate comprises diamond and silicon dioxide.

26. The method of claim 14 wherein the abrasive particles have an average size of less than about 150 micrometer.

27. The method of claim 14 wherein the powder further comprises at least one of thermoplastic or thermosetting resin particles.

28. The method of claim 27 wherein the thermoplastic resin particles have a melting point greater than about 60° C.

29. The method of claim 27 wherein the thermoplastic resin particles are selected from the group consisting of polyester and epoxy.

30. The method of claim 27 wherein the thermosetting resin particles are selected from the group consisting of phenolic, epoxy, urethane, ethylenically unsaturated resins, and combinations thereof.

31. The method of claim 15 wherein at least one of the first and second liner is textured.
